(19) United States
(12) Patent Application Publication
(10) Pub. No.: US 2016/0150259 A1
(43) Pub. Date: May 26, 2016

(54) CREATING AND BROADCASTING A CHANNEL TO ONE OR MORE DEVICES

(71) Applicants: Igor Sokolov, Saint-Petersburg (RU); Leonid Belyaev, Moscow (RU); Artem Kirakosyan, St. Petersburg (RU); Ilya Baronshin, Moscow (RU)

(72) Inventors: Igor Sokolov, Saint-Petersburg (RU); Leonid Belyaev, Moscow (RU); Artem Kirakosyan, St. Petersburg (RU); Ilya Baronshin, Moscow (RU)

(73) Assignee: SQUAREDON CO LTD, Larnaca (CY)

(21) Appl. No.: 14/549,367

(22) Filed: Nov. 20, 2014

(51) Int. Cl. H04N 21/2668; H04N 21/25; H04N 21/2543; H04N 21/235; H04N 21/2343; H04N 21/2385; H04N 21/258

(52) U.S. Cl. CPC H04N 21/2668; H04N 21/2385; H04N 21/251; H04N 21/25875; H04N 21/2353; H04N 21/234309; H04N 21/2543

(57) ABSTRACT

Channels are created and broadcasted to devices utilizing a platform. Disclosed is a system that can comprise: a customization component that facilitates creation of a channel comprising video content, a brand, a graphic identity, and at least one feature of the channel, wherein the channel is represented by a channel card displayable from a channel store storing channels representing channel cards; a management component that facilitates management of operations of the channel comprising a channel broadcast operation, a channel editing operation, and a channel consumption operation; a reporting component that collects channel financial information comprising payment information for payment from a first party to a second party, or billing information for billing the first party; and an analytical component that generates channel analytics information regarding the consumption of the channel or a behavior of an identity associated with the consumption of the channel.

### TECHNICAL FIELD

This disclosure relates generally to customized channels comprising live broadcast and previously broadcast video content presented at a channel store for purchase on a variety of devices.

### BACKGROUND

Traditionally, the work of broadcasting television (TV) channels to televisions arises from arrangements between a network administrator (e.g., cable, satellite, etc.) and a channel owner (also referred to as broadcaster). The network administrator distributes the channel via transmission of a broadcast signal. However, where the channel owner seeks to distribute the channel to various networks and devices, aside from television (e.g., computer, tablet, mobile device, etc.), the channel owner must incur costs to transcode the channel content to various network formats, device formats and specifications. Furthermore, the channel owner also incurs costs associated with developing an application to distribute the channel on various platforms (e.g., web, mobile, smart television, etc.) and application management fees. Other associated expenses incurred are in reference to promotions, advertising, and marketing related to the application. For many small channel owners or niche channel owners, distributing the channel to a single device (e.g., television) or many user devices is cost prohibitive. Given the high cost of distributing a channel across an established network to large audiences, the channel owner must attract advertisement revenues and bear distribution costs.

Furthermore, channel owners also must attend to the business of creating a channel brand identity, arranging relationships with advertisers to generate revenue, and develop a strategy to abide by network administrator rules. Currently, there is no solution that allows channel owners to distribute a channel to many devices, at an affordable rate, and granting flexibility in developing its own product rules regarding distribution.

The above-described background relating to live broadcasting of video content corresponding to a channel, is merely intended to provide a contextual overview of some current issues, and is not intended to be exhaustive. Other contextual information may become further apparent upon review of the following detailed description.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with a platform to create channels and distribute channels to multiple devices. In accordance with a non-limiting embodiment, in an aspect, a system is provided comprising a memory having stored thereon executable components; and a processor, coupled to the memory, configured to execute or facilitate execution of the executable components, the executable components comprising: a customization component, a management component, a reporting component and an analytical component.

In an aspect, the customization component facilitates creation of a channel comprising video content, a brand, a graphic identity, and at least one feature of the channel, wherein the channel is represented by a channel card displayable from a channel store storing channels representing channel cards; that management component facilitates management of operations of the channel comprising a channel broadcast operation, a channel editing operation, and a channel consumption operation; the reporting component that collects channel financial information comprising payment information for payment from a first party to a second party, or billing information for billing the first party; and the analytical component that generates channel analytics information regarding the consumption of the channel or a behavior of an identity associated with the consumption of the channel.

In various other embodiments, the system can further comprise an editing component that facilitates an addition, a deletion, an editing, an acceptance, a rejection, or a publishing of the channel to the channel store. Also, in an embodiment, the system can further comprise a receiver component that receives a set of broadcast signals corresponding to a set of video content, and wherein the set of broadcast signals comprises at least one of an internet protocol broadcast signal, a digital video broadcast signal, analog video signal, or a serial digital interface broadcast signal from at least one broadcast or IP source. In yet another aspect, an embodiment can comprise a grouping component that groups the set of broadcast signals corresponding to the set of video content into subsets of video content based on a topic, a brand, a price or an event, or a genre of the subset of video content.

The disclosure further discloses a method, comprising broadcasting, by a system comprising a processor, channels to a first device using a first broadcast format or a first IP stream and to a second device using a second broadcast format or a second IP stream; approving registration information received as input from a user identity associated with a subscription to a broadcast service of the system; creating a channel comprising video content, a specification for the channel, a feature for the channel; and receiving a request to publish the channel to a channel store comprising the channels managed by the system. In another aspect, the method can further comprise establishing a term subscription fee, a subscription fee corresponding to a video quality, or a royalty fee for the broadcast service. In yet another aspect, the method can further comprise verifying the registration information for the user identity associated with the broadcast service.

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a non-limiting exemplary system for creating and broadcasting a channel including channel creating, managing, reporting, and analyzing.

FIG. 2 illustrates a non-limiting exemplary system for creating and broadcasting a channel including channel creating, managing, reporting, analyzing, and editing.

FIG. 3 illustrates a non-limiting exemplary system for creating and broadcasting a channel including channel creating, managing, reporting, analyzing, editing, and receiving.

FIG. 4 illustrates a non-limiting exemplary system for creating and broadcasting a channel including channel creating, managing, reporting, analyzing, editing, receiving, and grouping.

FIG. 5 illustrates a non-limiting exemplary system for creating and broadcasting a channel including channel creating, managing, reporting, analyzing, editing, receiving, grouping, and tagging.

FIG. 6 illustrates a non-limiting exemplary system for creating and broadcasting a channel including channel creating, managing, reporting, analyzing, editing, receiving, grouping, tagging, and transcoding.

FIG. 7 illustrates a non-limiting exemplary system for creating and broadcasting a channel including channel creating, managing, reporting, analyzing, editing, receiving, grouping, tagging, transcoding, and billing.

FIG. 8 illustrates a schematic process flow diagram of an example method of rendering a channel to one or more devices.

FIG. 9 illustrates a schematic process flow diagram of an example method of broadcasting, approving, creating, and publishing a channel to one or more devices.

FIG. 10 illustrates a schematic process flow diagram of an example method of broadcasting, approving, creating, and publishing a channel to one or more devices.

FIG. 11 illustrates a schematic process flow diagram of an example method of approving an identity, managing registration information, and publishing a channel to one or more devices.

FIG. 12 illustrates a schematic process flow diagram of an example method of approving an identity, managing registration information, publishing a channel to one or more devices, and collecting a subscription fee.

FIG. 13 illustrates a block diagram representing an exemplary non-limiting networked environment in which the various embodiments can be implemented.

FIG. 14 illustrates a block diagram representing an exemplary non-limiting computing system or operating environment in which the various embodiments may be implemented.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As an overview of the various embodiments presented herein, to correct for the above identified deficiencies and other drawbacks of broadcasting video content to one or more devices, various embodiments are described herein to facilitate the creating, managing, and broadcasting of a dynamic channel including video streams (e.g., live and previously broadcasted content), audio streams (e.g., live and previously broadcasted content), and metadata, in agreed upon specifications and formats to various devices. In an aspect, the dynamic channel can be created in a manner customized to the desire of the channel broadcaster. The broadcaster can manage the channel, add content to the channel, delete content from the channel, add a new channel, delete an existing channel, edit a channel, submit a channel for publication, set rules corresponding to the channel, define channel features, establish subscription prices, establish terms of channel use, collect revenue based on subscription fees from consumers consuming the channel, review channel consumption analytics, and distribute the channel across platforms accessible by numerous devices.

In an aspect, the channels themselves can be presented at a channel store where consumers can browse through channel catalogues and select those channels most appealing for consumption. The channel store allows for efficient consumption of content wherein the consumer views and pays for only those channels of interest. Traditionally, networks, such as television networks charge a set amount of money for a bundle of channels, some of which the consumer may not wish to consume. The channel store comprising smart channels allows the consumer to select a channel of interest a-la carte, learn about the channel contents, and purchase the channel on any of a variety of devices (e.g., television, set-top box, mobile device, etc.).

The channel store also benefits channel owners or creators of channel content (also referred to as broadcasters), wherein the channel store provides a platform for broadcasters to present and sell channels to consumers on several devices. In an aspect, the platform provides a means whereby a broadcaster can store a channel, convert the stored information to a variety of format and specification requirements belonging to a range of devices, transmit the converted information to the devices, present the information at a channel store, allow consumers to subscribe to the channel for a fee and consume the content from the subscribed channel. The platform and channel store is a one-stop shop for a broadcaster allowing the channel to reach a wide audience, distributing the channel to multiple devices, reducing the overhead associated with traditional broadcasting, and increasing the revenue generated by providing content choice to the consumer.

In an aspect, the system provides a dynamic platform that allows a broadcaster to distribute channel comprising a brand identity and video content to televisions, mobile devices, tablets, personal computers and other such devices. Furthermore, the platform facilitates the broadcaster to control the selling business model (e.g. defining trial period conditions, subscription rules, etc.), promotional strategy, and channel content. Also, the platform provides a means for the broadcaster to reach a targeted audience and assess channel analytics regarding consumption, revenue generation, and performance of content. Moreover, the broadcaster can utilize the platform tools to manage the channel content and channel operations in an efficient and user-friendly manner to adapt to the demand of the consumers.

In an aspect, the broadcaster can also promote, market, or advertise content and the channel as the product itself at the channel store via the platform. The broadcaster can also receive a payment from a consumer via the channel store interface in accordance with established prices or subscription fees for access to the channel. Furthermore, the broadcaster can define the price and terms of the channel to be offered at the channel store. In another aspect, the channel can also be promoted, using video content snippets and/or its metadata, within the smart channel service or other channels. In another aspect, the broadcaster has control over the customization of the channel, by creating channel cards representing the channel, wherein the channel cards can comprise logos, branding elements, video trailers, and other such channel attributes that can be deployed at the channel store. In another aspect, the channel cards can comprise a channel title, a channel description, popular video content for the channel, a video content trailer, an age rating of the video content or the whole channel, a channel genre, a channel price, purchasing options, video content streaming options, or subscription information relating to a subscription to the channel. Metadata can be used to present channel and content in it.

In another aspect, the system platform allows for the management of channels via system editors. An editor (e.g., the authority over the system or administrator of the system) of the system platform can add channels, delete channels, accept a channel for publication to the channel store or reject a channel for publication to the channel store. The platform provides a user-friendly interface for a system editor to administer the system operations and manage channel broadcasters and channel consumer's system activities. The system provides a useful platform for editors, broadcasters and consumers while providing a flexible means to administer the tasks related to distributing content, broadcasting customized content to a large audience, and consuming unique content of interest at a range of personal devices.

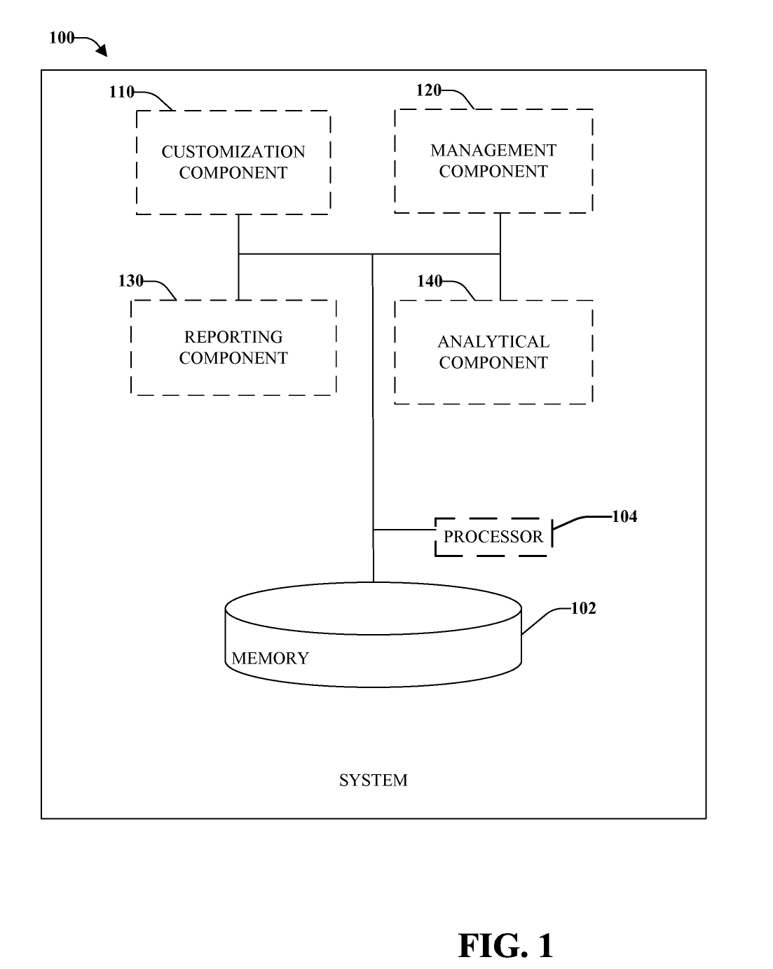

These and other embodiments or implementations are described in more detail below with reference to the drawings. Referring now to FIG. 1, illustrated is a non-limiting exemplary system 100 for creating, managing, and broadcasting a channel. In an aspect, system 100 comprises a memory 102 having stored thereon executable components; and a processor 104, coupled to the memory 102, configured to execute or facilitate execution of the executable components, the executable components comprising: a customization component 110 that facilitates creation of a channel comprising video content, a brand, a graphic identity, and at least one feature of the channel, wherein the channel is represented by a channel card displayable from a channel store storing channels representing channel cards; a management component 120 that facilitates management of operations of the channel comprising a channel broadcast operation, a channel editing operation, and a channel consumption operation; a reporting component 130 that collects channel financial information comprising payment information for payment from a first party to a second party, or billing information for billing the first party; and an analytical component 140 that generates channel analytics information regarding the consumption of the channel or a behavior of an identity associated with the consumption of the channel.

In an aspect, customization component 110 facilitates the creation of a channel wherein the channel comprises video content, a brand, a graphic identity, and at least one feature of the channel. System 100 is dynamic in that it provides a platform for broadcasters of channels to create a channel with its own brand identity to convey to consumers. The brand identity can comprise distinguishing features such as unique logos to represent the channel or organization promoting the channel, color schemes (e.g. fonts, imagery, colors) associated with a channel theme, slogans (e.g., tagline or catch phrase), theme music, channel name, and other elements of branding. The channel can also be created to comprise customized video content such as shows, movies, music performances, sporting events and other such content.

In an aspect, the channel can comprise any number of features customized by the broadcaster such features include the ability to broadcast live content, broadcast previously recorded content, scroll through a schedule of previously broadcasted content (e.g., an electronic program guide), present channel trailers, provide a channel preview setting (e.g., channel demonstration mode with limited functionality), list popular programs on the channel and its metadata, promote trailers of popular programs, provide a time period (e.g., subscription duration) for which previously broadcasted content or live content is accessible by the consumer, provide consumers access to content that will be broadcasted in the future on channel, provide channel quality options (e.g., screen size, hi-definition, canvas dimensions, display resolutions, color settings, brightness, etc.), provide video streaming options, provide sound setting options (e.g. volume, bass, treble, language options, a number of channels, sound enhancing technologies, amplifier, equalization, phase manipulation, etc.), provide access to channel content on customer devices (e.g., TVs, Set top Box's (STB), mobile devices), provide channel content for streaming over Wi-Fi or a cellular network, provide channel content to be downloaded and accordingly consumed offline, provide territorial specifications of the channel availability, provide grouping options of previously broadcasted content in a channel after purchase by consumers, provide content items prohibited for viewing after being broadcasted live, provide content items prohibited from live viewing, provide pricing options for a different set of features or set of prices corresponding to a set of features, configure channel settings or features by a channel broadcaster or system administrator, provide a billing period and corresponding prices for different billing periods, provide payment options to consumers (e.g., credit card, phone payment, e-money or any combination of payments) where the payment options are established by the broadcaster, provide trial and trial options for accessing the channel content and channel itself, provide tools to bundle channels to packages and offering the bundle of channels as a product to consumers with its own set of customized features.

The system provides a platform with many tools available to the broadcaster to create a channel comprising a particular business model, a unique identity, dynamic content, customized features, and the devices. The ability of the broadcaster to control so many of the broadcasting elements is unique to system 100. The broadcaster also has the ability to reach a wide target audience by distributing channel to consumers at a channel store where consumers can browse through channel catalogues and select those channels most appealing for consumption. The channel store allows for efficient consumption of content wherein the consumer views and pays for only those channels of interest. The channel store comprising channels allows the consumer to select a channel of interest, learn about the channel contents, and purchase the channel on any of a variety of devices (e.g., television, set-top box, mobile device, etc.). The channel store also allows broadcasters to a platform to distribute its channel to a wide range of audiences and take advantage of the ability to broadcast to a number of devices without undertaking the burden of developing multiple formats and specifications suited to the number of devices.

In another aspect, a channel card represents a channel at the channel store. The channel cards can convey information about the channel such as a channel description, content trailers, subscription pricing, and trial service information. Furthermore, the channel cards can provide information to educate a potential consumer about the channel capabilities such as the devices that can access the channel, quality of the video content (including sound technology), language translations, age rating of content, and other such information. In another aspect, a consumer can browse through the channel cards to view promotional videos, popular content pricing information, and trial subscription information related to the channel information. In an aspect, to facilitate easier browsing, the channel cards can be sorted by genre, topic, age rating, or other such criteria.

In an aspect, the broadcaster can create a channel by registering into the system 100. The broadcaster can create a registration profile by accepting the system 100 terms of service, inputting company details, and inputting bank account details. The system 100 editor or administrator can verify the details and permit the broadcaster to create a channel based on the verification. Thus the broadcaster can create the channel and manage the channel activities via system 100. Accordingly, system 100 employs a management component 120 that facilitates management of operations of the channel comprising a channel broadcast operation, a channel editing operation, and a channel consumption operation. In an aspect, management of channel broadcast operations include sending a request to the administrator to publish a channel, defining price and trial terms for using the channel, defining a source for the content stream (e.g., satellite or internet protocol (IP)), defining an electronic program guide (and associated metadata) corresponding to the video content, defining video content to blackout (e.g., prevent content from being displayed to certain content subscribers, devices or territories) for particular content and particular devices (e.g, TV, STB, mobile devices) as well as particular delivery methods (Over the Top Content (OTT), IP, cable, etc.), seeking approval for updates to channel promotional metadata, seeking approval to view and export channel usage analytics, or seeking approval to receive financial information corresponding to the channel.

In another aspect, management component 120 can facilitate management of a channel editing operation. In an aspect a channel editing operation can comprise a broadcasters act of naming the channel, designing logo's, designing branding graphics to the channel, adding featured shows to the channel and other video content, creating and editing trailers, as well as creating and editing promotional materials. In another aspect, the channel editing operations can be performed by the editor or system administrator who can approve a broadcaster to create a channel, manage a broadcasters account details (e.g., keep track of number of subscribers, revenue collected, etc.), approve channels to publish to the catalogue at the channel store, and edit channel metadata. Management component 120 can also manage a channel consumption operation such as managing settings corresponding to the video content (e.g., picture quality, sound quality, language settings, age ratings, etc.), the devices capable of accessing the video content, popularity rating of channels, and managing subscribers feedback regarding a channel or video content.

In yet another aspect, system 100 employs reporting component 130 that collects channel financial information comprising payment information for payment from a first party to a second party, or billing information for billing the first party. In an aspect, the reporting component 130 collects financial information related to any transaction associated with the channels. For instance, financial and payment information collected can include, revenue from advertisements, revenue from subscriptions, revenue from additional features, royalty revenue promotional expenses, royalty expenses, registration expenses, broadcasting expenses, discounts, premiums, and other such financial information. Furthermore, the reporting component 130 can report information related to any stakeholder of the system 100 including broadcasters, editors, and consumers. The collection of such financial information assists the user in accounting for cash flows and reconciling billing matters.

In an instance, a broadcaster can define a monthly or annual subscription fee to charge for channel subscriptions. Reporting component 130 can collect such annual financial information based on the subscription fees. In another aspect, reporting component 130 can also collect channel information related to revenue collected based on price variables such as the quality of the video content, audio content, percentage of blacked-out content, royalty rates (e.g., broadcaster receives a percentage of the net price less the value-added tax assessed to the revenue collected). Reporting component 130 can also collect information based on royalty payment transfers from the system to a broadcaster bank account or system administrator bank account.

In another aspect, system 100 employs an analytical component 140 that generates channel analytics information regarding the consumption of the channel or a behavior of an identity associated with the consumption of the channel. In an aspect, a broadcaster can learn about viewing trends and the behavior of subscribers in relation to video content corresponding to a channel. For instance, analytical component 140 can generate analytics that determine the quality of the video content presented and the level of engagement of the audience in relation to the video content. In another aspect, analytical component 140 can generate analytics related to the number of consumer views of a video, the number of clicks an advertisement receives, the average time spent by a consumer viewing particular content, the popularity level of particular content, and the subscription as well as renewal habits of the consumers. Furthermore, in an aspect, analysis of data associated with user viewing behavior can be used to suggest or provide options for viewing video content related to the data associated with the user viewing behavior. User viewing behavior and personalization of the channel can be associated with a user identification method, including but not limited to, user logins, passwords, face recognition, biometrics, mobile device pairing, etc.

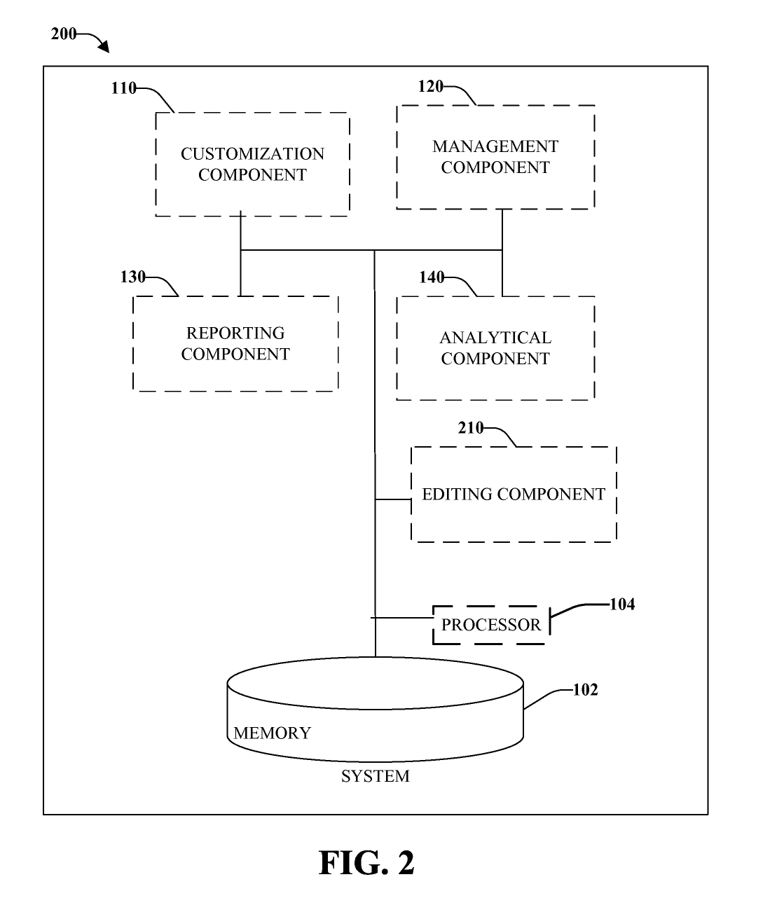

Turning now to FIG. 2, illustrated is a non-limiting exemplary embodiment of system 200 for creating and broadcasting a channel. In an aspect, system 200 employs editing component 210 that facilitates an addition, a deletion, an editing, an acceptance, a rejection, or a publishing of the channel to the channel store. In an aspect, editing component 210 can facilitate the adding of a video where the adding can comprise uploading digital video recordings to be viewed by consumers of the channel. The adding of the video can include the addition of various details such as the resolution of the video (e.g., video window size at which the video is encoded or measured in pixels), whether the video is to be available by streaming or downloading or both, any language translations, the video format (e.g., .avi, .mov, .mpg, etc.), any keywords or tags provided in association with the video content.

Similarly, a channel can be deleted as well, such that the channel and corresponding content is removed from the channel store. The acts of adding and deleting a channel can be performed by either a system editor or a broadcaster. In another aspect, editing component 210 can facilitate publishing of a channel. The task of publishing a channel belongs to a system administrator unless an arrangement is specified to allow the broadcaster to publish a channel. The publishing can comprise verifying that the video content to be published by the channel does belong to the broadcaster. Furthermore, the publishing can include ensuring the format of the video content is appropriate for transcoding into device formats and specifications. In another aspect, the publisher can also determine whether all royalty fees, licensing fees, and advance payments have occurred prior to the publishing.

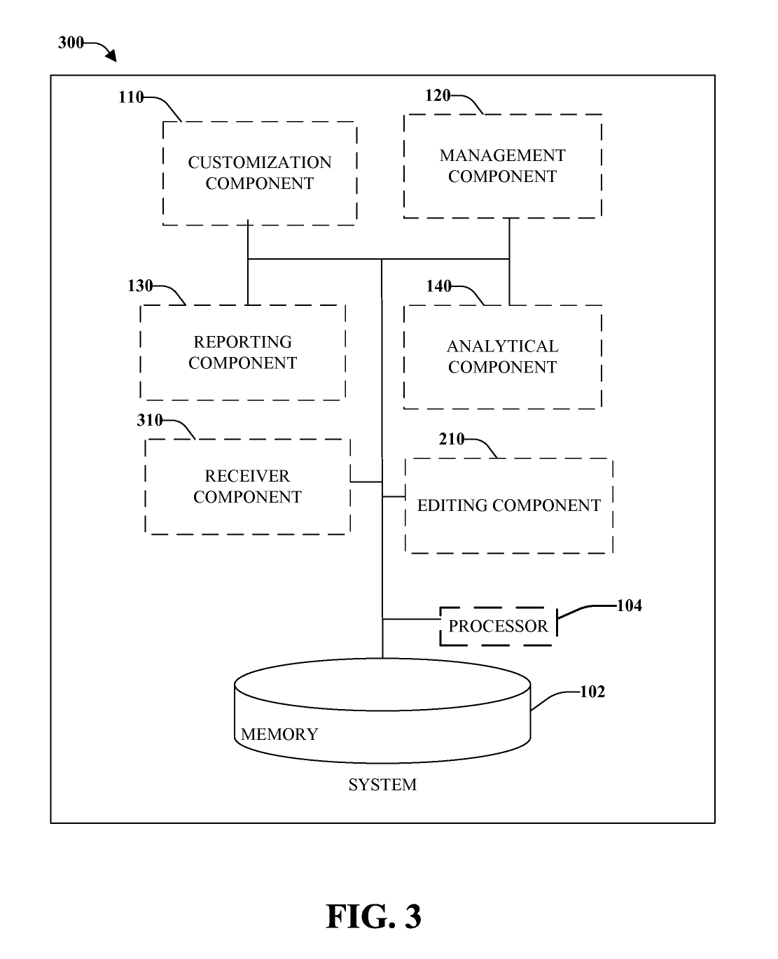

Turning now to FIG. 3, illustrated is a non-limiting exemplary embodiment of system 300 for creating and broadcasting a channel. In an aspect, system 300 employs receiver component 310 that receives a set of broadcast signals corresponding to a set of video content, and wherein the set of broadcast signals comprises at least one of an internet protocol broadcast signal, a digital video broadcast signal, an analog video signal, or a serial digital interface broadcast signal from at least one broadcast source or IP source. In an aspect, the receiver component 310 can facilitate the receipt of any of a variety of broadcast signals by numerous devices. Each type of broadcast signal can support the distribution of various video content services including live television (e.g., with or without interactive features), time-shifted video content (e.g., distributes video content displayed in the past), and video on demand (e.g., browsing catalogued videos).

In another aspect, each type of broadcast signal is capable of standardizing the broadcast process to match country standards worldwide including digital format standards (e.g., DVB, ISDB, DVT-2 standard, DVB-S, DVB-C, DVB-S, ATSC, DMB, DMB-TH, DTT, etc.,) and analog broadcast standards (e.g., FCS, MAC, MUSE, NTSC, PAL, RS-343, SECAM, etc.). Furthermore, in an aspect, receiver component 310 can receive a set of digital video broadcasting signals that make use of any of a variety of data distribution approaches such as satellite, cable, terrestrial television, or microwave. In yet another aspect, video content can be received in a variety of ways by receiving component 310 including wireless broadcast (e.g., analog or digital signal) or via a closed circuit system (e.g., via coaxial cable).

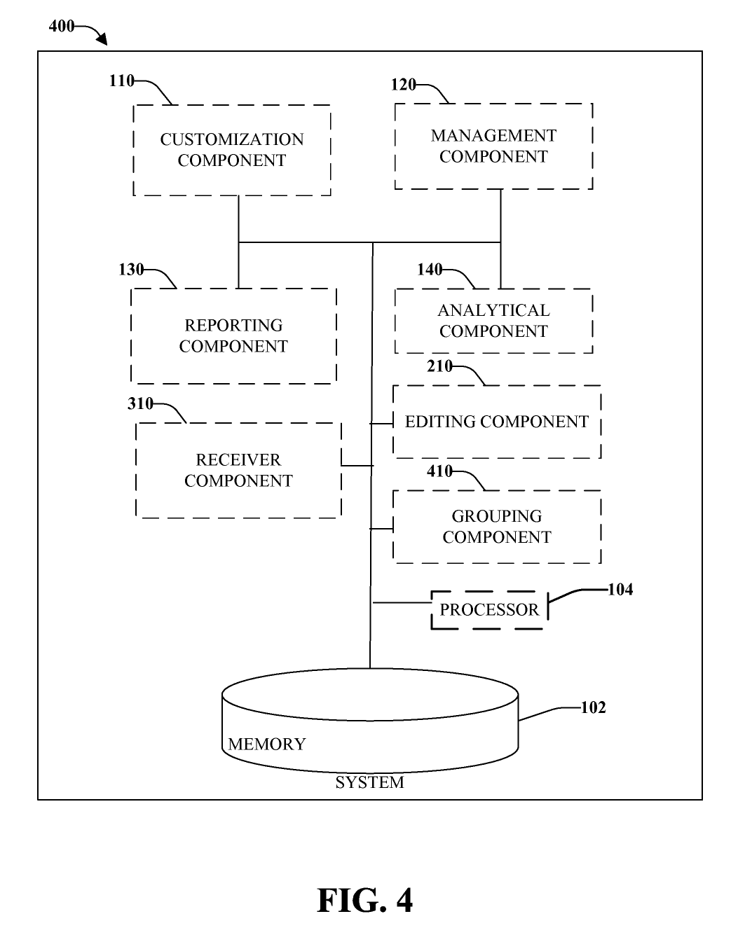

Turning now to FIG. 4, illustrated is a non-limiting exemplary embodiment of system 400 for creating and broadcasting a channel. In an aspect, system 400 employs grouping component 410 that groups the set of broadcast signals corresponding to the set of video content into subsets of video content based on a topic, a brand, a price or an event, or a genre of the subset of video content. By grouping a set of broadcast signals corresponding to sets of video content, grouping component 410 can group video episodes of a specific franchise and broadcast the content to various destinations as a group accessible by various devices. For instance, a franchise of television episodes corresponding to a channel can be grouped (e.g., using grouping component 410) and broadcasted to numerous countries to be received (e.g., using receiver component 310) by various devices.

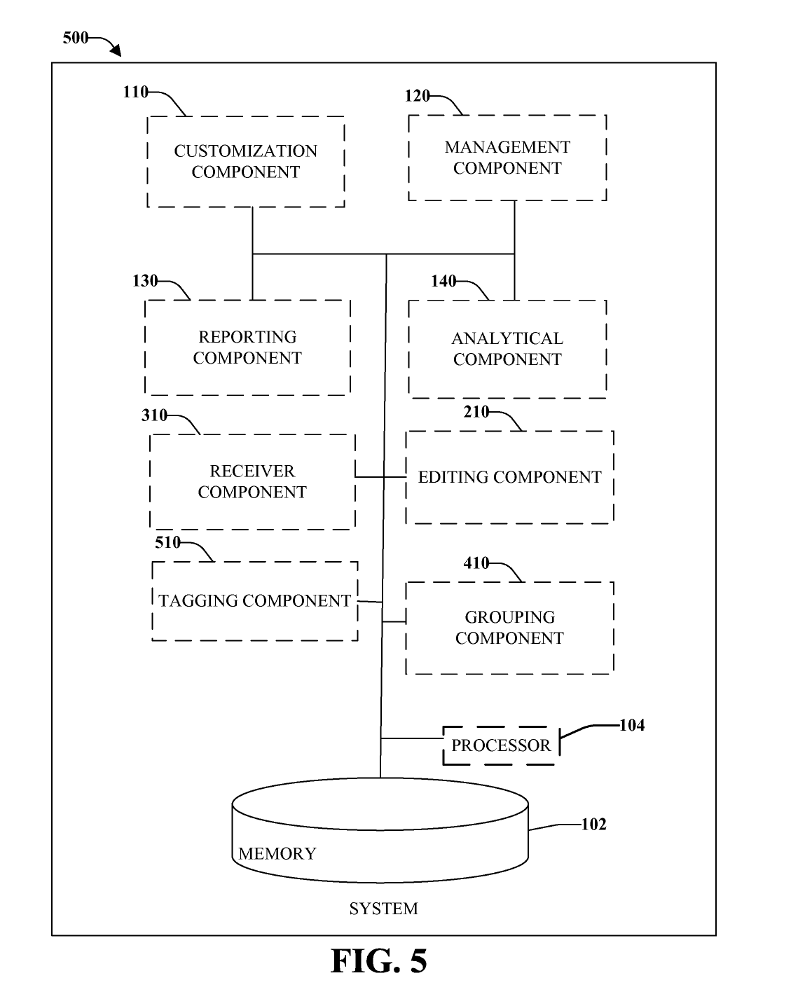

Turning now to FIG. 5 illustrated is a non-limiting exemplary embodiment of system 500 for creating and broadcasting a channel. In an aspect, system 500 employs a tagging component 510 that tags the subset of video content with keywords, terms, or labels to facilitate description of the subset of video content. In an aspect, the channel can also be promoted, using video content snippets and/or its metadata, within the smart channel service or other channels. Metadata can be used to describe or personalize the channel and corresponding video content.

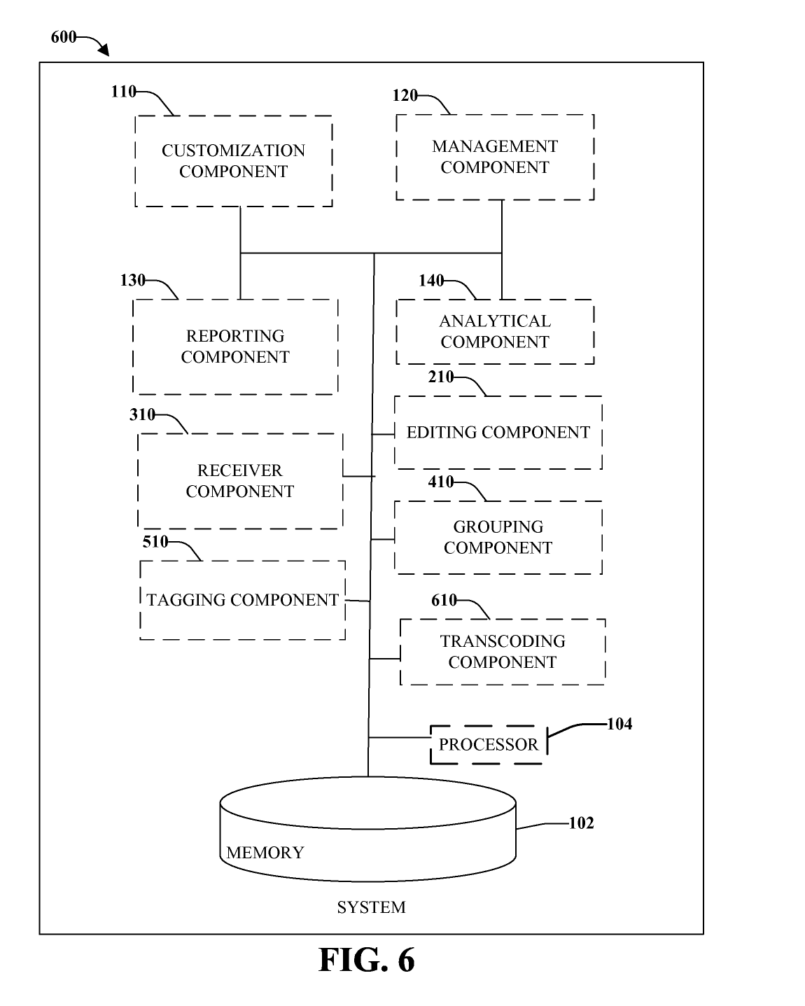

Turning now to FIG. 6 illustrated is a non-limiting exemplary embodiment of system 600 for creating and broadcasting a channel. In an aspect, system 600 employs a transcoding component 610 that transcodes data streams from at least one source to target formats corresponding to target devices to which the data streams are to be transmitted. In an aspect, transcoding component 610 can transcode data streams representing information. The information corresponding to the data streams can include data, such as media data (e.g., audio data, video data, streaming content, video games, shows, etc.) and metadata. Transcoding component 610 converts information from one format to a different format of one or more devices. A format can describe a manner to encode information so as to satisfy the criteria of a storage medium corresponding to a device. A format can correspond to a particular specification, which describes the method by which data or information is to be encoded. For instance, in an aspect, transcoding component 610 can convert media files, such as audio files and video files from one format to another formats such as mobile device formats (e.g., 3^{rd} Generation Partnership Project (3GPP), Motion Picture Experts Group (MPEG-4), Real Time Streaming Protocol (RTSP), Flash Lite, etc.), tablet formats, and other such device formats. Transcoding component 610 can also convert HTML files and graphic files to formats and specifications associated with mobile devices and web-enabled products.

In an aspect, the conversion of information to a device format or in accordance with a device specification can result in information used to in relation to features of the device such as screen size, memory capacity, and bandwidth rates. Furthermore, in an aspect, transcoding component 610 can transcode information to be compatible with an application or program specific to a device. In another aspect, the conversion of information can include transcoding to file formats that reduce file sizes or to update data formats to newer versions that are better supported by a wider array of devices.

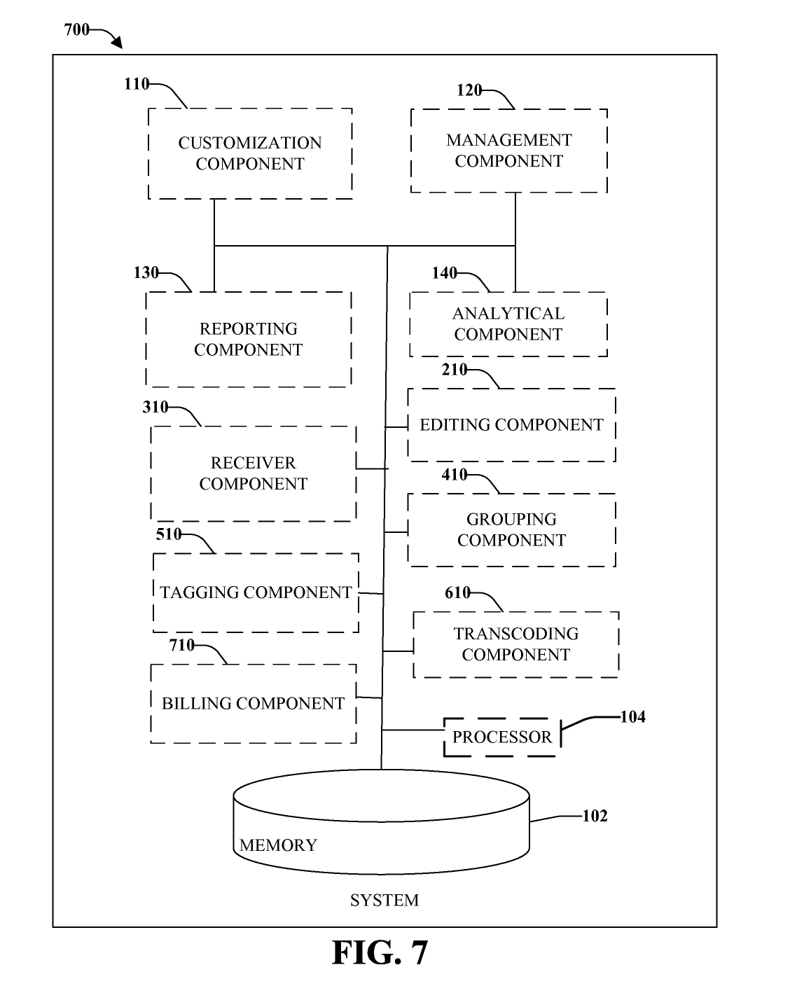

Turning now to FIG. 7 illustrated is a non-limiting exemplary embodiment of system 700 for creating and broadcasting a channel. In an aspect, system 700 employs a billing component 710 that determines a payment related to the channel purchased by a consumer. In an aspect, billing component 710 can comprise determining a payment associated with the purchasing of a channel. As a consumer subscribes to various channels the consumer will incur a subscription fee. In an aspect, billing component 710 determines a fee based on the channels selected and the fee can be based on various models. In an instance, each channel can cost a flat fee per channel. The flat fee per channel can include a range of flat fees based on the length of the subscription timeframe such that the longer the subscription commitment, the lower the fee incurred by the consumer. In another aspect, billing component 710 can determine a fee based on aggregate channel discounts. For instance, the fee can be lessened as a consumer purchases more channel subscriptions. Thus bulk or group channel purchases can reward customers with lower fees.

Furthermore, billing component 710 can determine a discounted fee for a subscription to a bundle of channels. In an aspect, such discounts can help facilitate subscription revenue for weaker selling channels by including them in a discounted bulk purchase of channels. Billing component 710 can incorporate such discounts based on broadcaster specified or administrator specified directives. In another aspect, billing component 710 can determine a fee based on premium fee models. For instance, a premium fee model can associate premium payments with niche-oriented content based on specific audience interests such as live musical performances, premium show content, and exclusive sporting events. In another aspect, billing component 710 can determine the customized fee based on a la carte services optionally provided to the consumer such as providing a second screen of information to accompany a particular event or event simulcasting on a device. Furthermore, the customized fee can be adjusted based on special offerings such as holiday discounts, free limited time content access, coupon promotions, or mobile device quick codes.

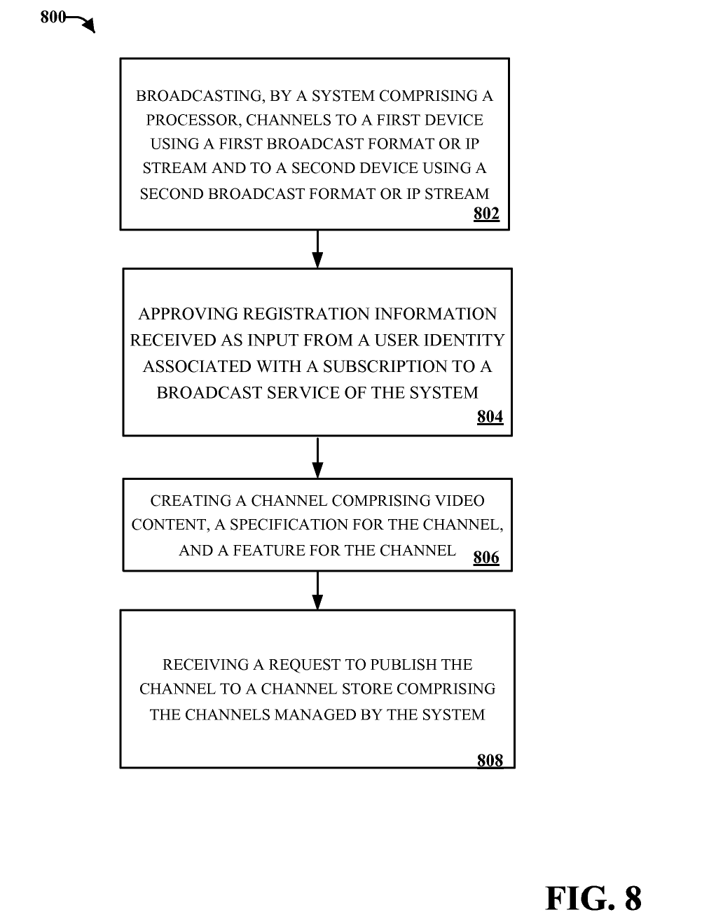

Turning now to FIGS. 8-14 illustrated are methods and/or flow diagrams in accordance with the disclosed subject matter. For simplicity of explanation, the methods are depicted and described as a series of acts. It is to be understood and appreciated that the subject disclosure is not limited by the acts illustrated and/or by the order of acts, for example acts can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be further appreciated that the methods disclosed hereinafter and throughout this specification are capable of being stored on an article of manufacture to facilitate transporting and transferring such methods to computers. The term article of manufacture, as used herein, is intended to encompass a computer program accessible from any computer-readable device, carrier, or media.

Referring to FIG. 8, disclosed in accordance with the subject matter is an example method 800 that provides a platform, by a system, to broadcast customized channels to numerous devices. At 802, a system comprising a processor can be configured to broadcast channels to a first device using a first broadcast format or IP stream and to a second device using a second broadcast format or IP stream. At 804, the system can be configured to approve registration information received as input from a user identity associated with a subscription to a broadcast service of the system. At 806, the system can be configured to create a channel comprising video content, a specification for the channel, and a feature for the channel. At 808, the system can be configured to receive a request to publish the channel to a channel store comprising the channels managed by the system.

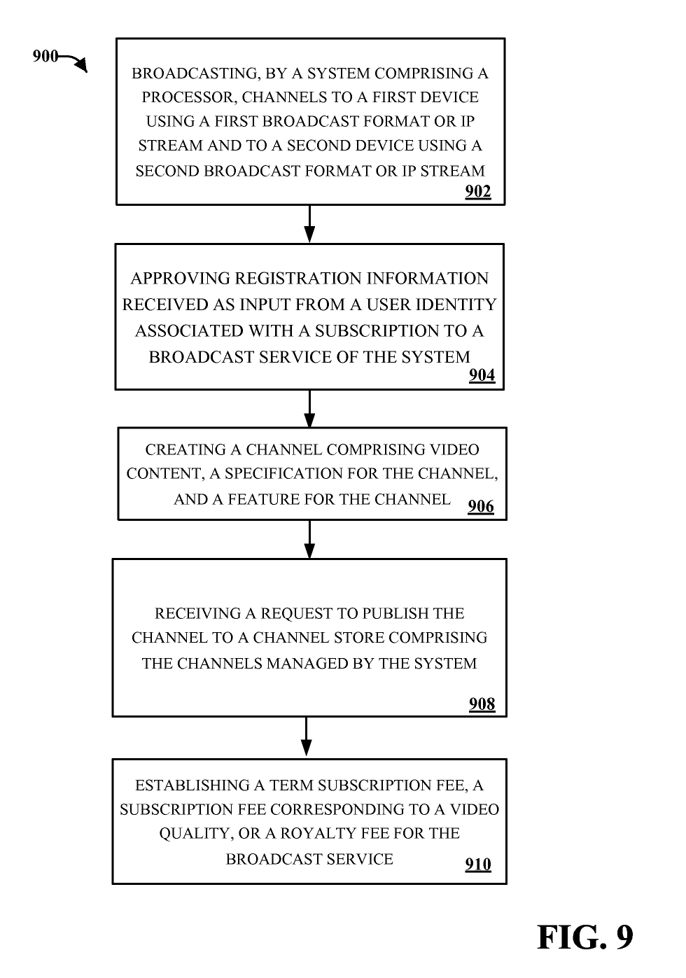

Referring to FIG. 9, disclosed in accordance with the subject matter is an example method 900 that provides a platform, by a system, to broadcast customized channels to numerous devices. At 902, a system comprising a processor can be configured to broadcast channels to a first device using a first broadcast format or IP stream and to a second device using a second broadcast format or IP stream. At 904, the system can be configured to approve registration information received as input from a user identity associated with a subscription to a broadcast service of the system. At 906, the system can be configured to create a channel comprising video content, a specification for the channel, and a feature for the channel. At 908, the system can be configured to receive a request to publish the channel to a channel store comprising the channels managed by the system. At 910, the system can be configured to establish a term subscription fee, a subscription fee corresponding to a video quality, or a royalty fee for the broadcast service.

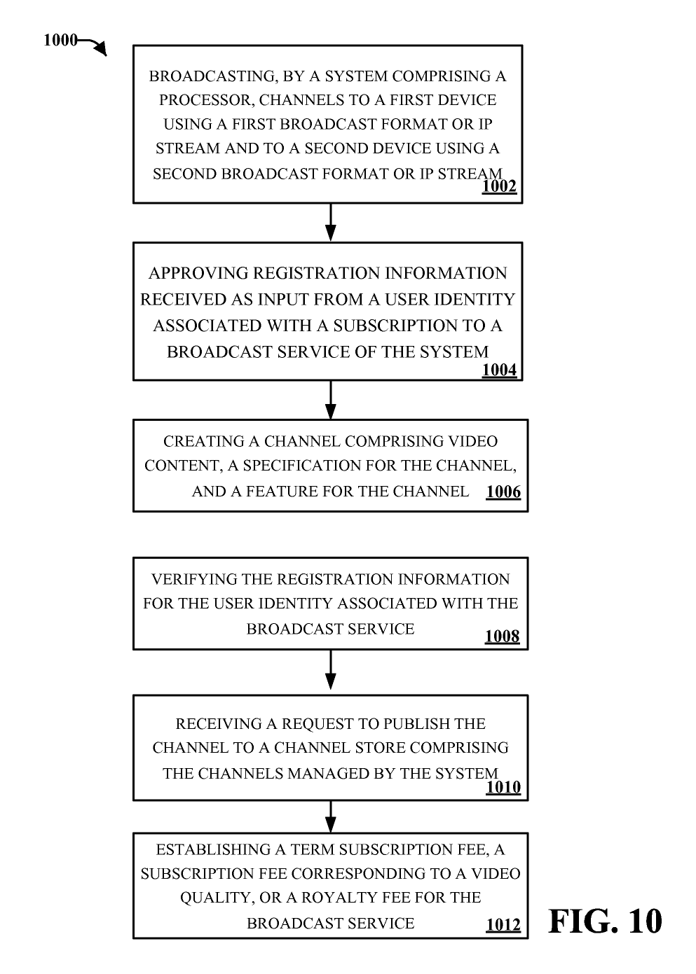

Referring to FIG. 10, disclosed in accordance with the subject matter is an example method 1000 that provides a platform, by a system, to broadcast customized channels to numerous devices. At 1002, a system comprising a processor can be configured to broadcast channels to a first device using a first broadcast format or IP stream and to a second device using a second broadcast format or IP stream. At 1004, the system can be configured to approve registration information received as input from a user identity associated with a subscription to a broadcast service of the system. At 1006, the system can be configured to create a channel comprising video content, a specification for the channel, and a feature for the channel. At 1008, the system can be configured to verify the registration information for the user identity associated with the broadcast service. At 1010 the system can be configured to receive a request to publish the channel to a channel store comprising the channels managed by the system. At 1010, the system can be configured to establish a term subscription fee, a subscription fee corresponding to a video quality, or a royalty fee for the broadcast service.

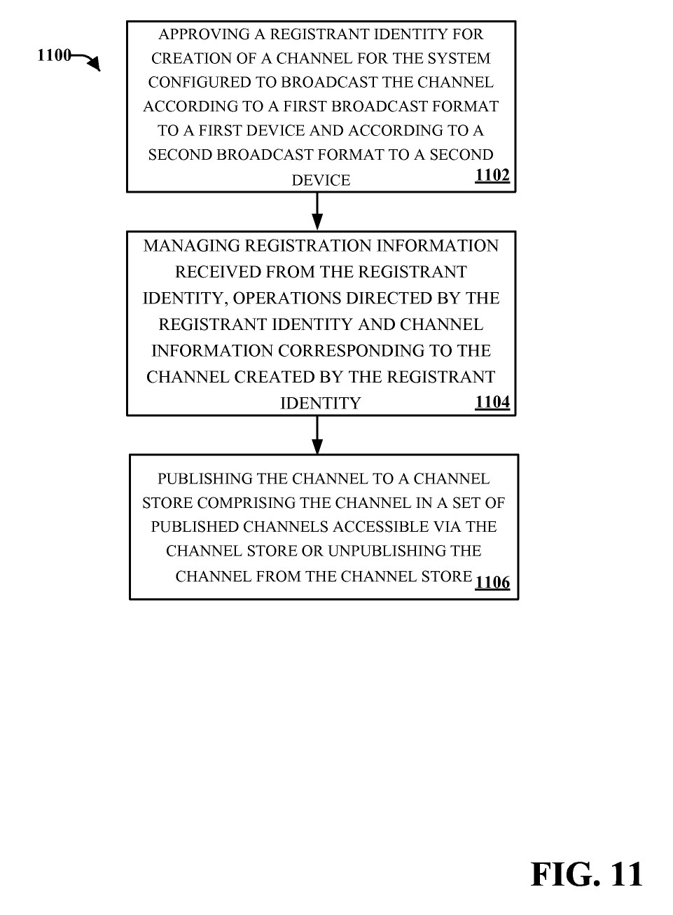

Referring to FIG. 11, disclosed in accordance with the subject matter is an example method 1100 that provides a platform, by a system, to broadcast customized channels to numerous devices. At 1102, a system comprising a processor can be configured to approve a registrant identity for creation of a channel for the system configured to broadcast the channel according to a first broadcast format to a first device and according to a second broadcast format to a second device. At 1104, the system can be configured to manage registration information received from the registrant identity, operations directed by the registrant identity and channel information corresponding to the channel created by the registrant identity. At 1106, the system can be configured to publish the channel to a channel store comprising the channel in a set of published channels accessible via the channel store or unpublishing the channel from the channel store.

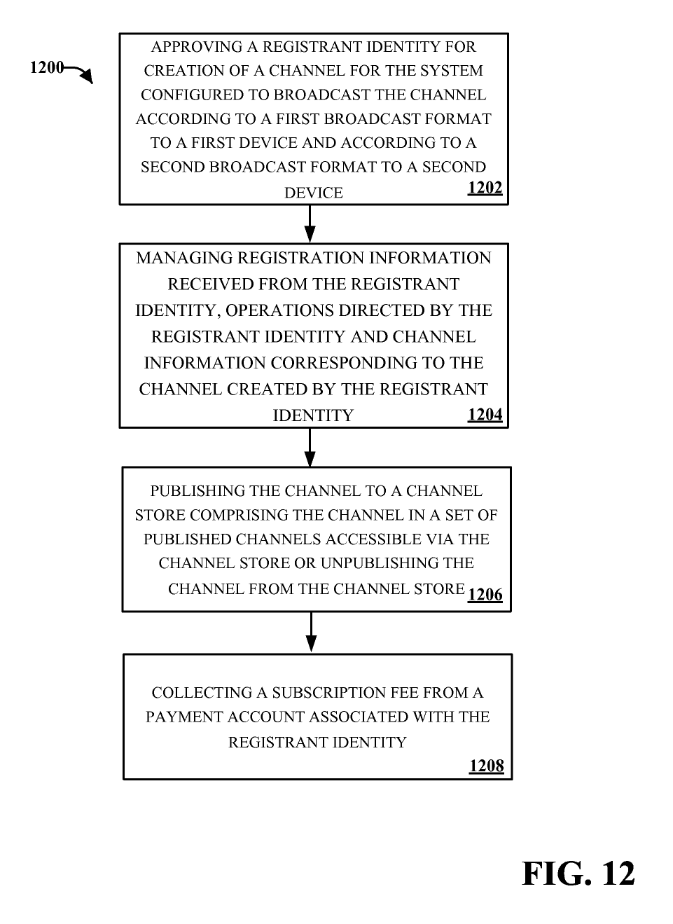

Referring to FIG. 12, disclosed in accordance with the subject matter is an example method 1200 that provides a platform, by a system, to broadcast customized channels to numerous devices. At 1202, a system comprising a processor can be configured to approve a registrant identity for creation of a channel for the system configured to broadcast the channel according to a first broadcast format to a first device and according to a second broadcast format to a second device. At 1204, the system can be configured to manage registration information received from the registrant identity, operations directed by the registrant identity and channel information corresponding to the channel created by the registrant identity. At 1206, the system can be configured to publish the channel to a channel store comprising the channel in a set of published channels accessible via the channel store or unpublishing the channel from the channel store. At 1208, the system can be configured to collect a subscription fee from a payment account associated with the registrant identity.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

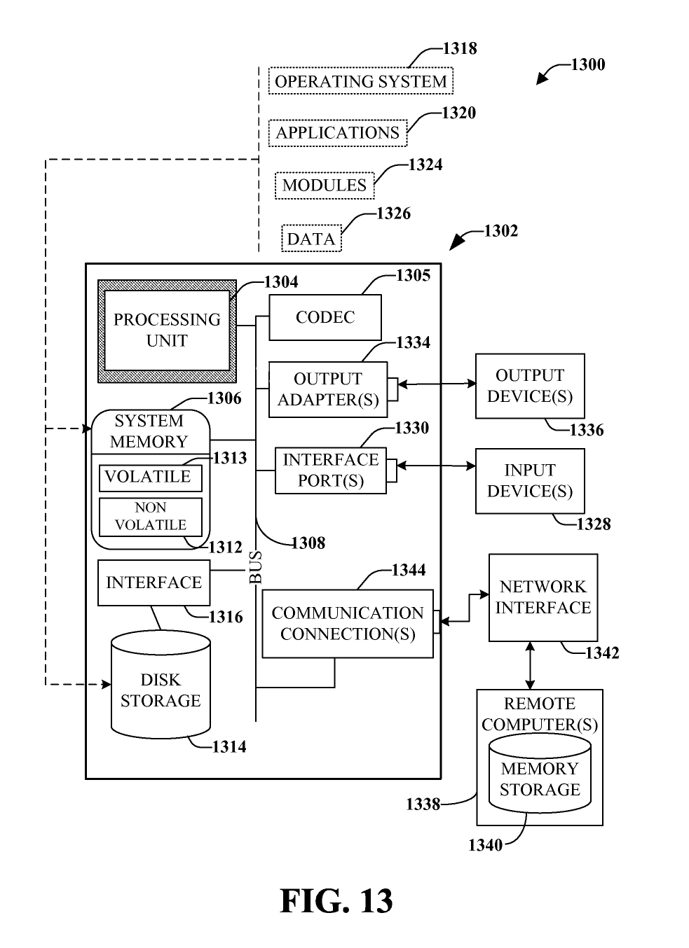

With reference to FIG. 13, a suitable environment 1300 for implementing various aspects of the claimed subject matter includes a computer 1302. The computer 1302 includes a processing unit 1304, a system memory 1306, a codec 1305, and a system bus 1308. The system bus 1308 couples system components including, but not limited to, the system memory 1306 to the processing unit 1304. The processing unit 1304 can be any of various available processors. Dual microprocessors and other multiprocessor architectures also can be employed as the processing unit 1304.

The system bus 1308 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1306 includes volatile memory 1310 and non-volatile memory 1312. The basic input/output system (BIOS), containing the basic routines to transfer information between elements within the computer 1302, such as during start-up, is stored in non-volatile memory 1312. In addition, according to various embodiments, codec 1305 may include at least one of an encoder or decoder, wherein the at least one of an encoder or decoder may consist of hardware, a combination of hardware and software, or software. Although, codec 1305 is depicted as a separate component, codec 1305 may be contained within non-volatile memory 1312. By way of illustration, and not limitation, non-volatile memory 1312 can include read only memory (ROM), programmable ROM (PROM), electrically programmable ROM (EPROM), electrically erasable programmable ROM (EEPROM), or flash memory. Volatile memory 1310 includes random access memory (RAM), which acts as external cache memory. According to present aspects, the volatile memory may store the write operation retry logic (not shown in FIG. 13) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1302 may also include removable/non-removable, volatile/non-volatile computer storage medium. FIG. 13 illustrates, for example, disk storage 1314. Disk storage 1310 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1314 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1314 to the system bus 1308, a removable or non-removable interface is typically used, such as interface 1316.

It is to be appreciated that FIG. 13 describes software that acts as an intermediary between users and the basic computer resources described in the suitable operating environment 1300. Such software includes an operating system 1318. Operating system 1318, which can be stored on disk storage 1314, acts to control and allocate resources of the computer system 1302. Applications 1320 take advantage of the management of resources by the operating system through program modules 1324, and program data 1326, such as the boot/shutdown transaction table and the like, stored either in system memory 1306 or on disk storage 1314. It is to be appreciated that the claimed subject matter can be implemented with various operating systems or combinations of operating systems.

A user enters commands or information into the computer 1302 through input device(s) 1328. Input devices 1328 include, but are not limited to, a pointing device such as a mouse, trackball, stylus, touch pad, remote control unit, keyboard, microphone, joystick, game pad, satellite dish, scanner, TV tuner card, digital camera, digital video camera, web camera, and the like. These and other input devices connect to the processing unit 1304 through the system bus 1308 via interface port(s) 1330. Interface port(s) 1330 include, for example, a serial port, a parallel port, a game port, and a universal serial bus (USB). Output device(s) 1336 use some of the same type of ports as input device(s) 1328. Thus, for example, a USB port may be used to provide input to computer 1302, and to output information from computer 1302 to an output device 1336. Output adapter 1334 is provided to illustrate that there are some output devices 1336 like monitors, speakers, and printers, among other output devices 1336, which require special adapters. The output adapters 1334 include, by way of illustration and not limitation, video and sound cards that provide a means of connection between the output device 1336 and the system bus 1308. It should be noted that other devices and/or systems of devices provide both input and output capabilities such as remote computer(s) 1338.

Computer 1302 can operate in a networked environment using logical connections to one or more remote computers, such as remote computer(s) 1338. The remote computer(s) 1338 can be a personal computer, a server, a router, a network PC, a workstation, a microprocessor based appliance, a peer device, a smart phone, a tablet, or other network node, and typically includes many of the elements described relative to computer 1302. For purposes of brevity, only a memory storage device 1340 is illustrated with remote computer(s) 1338. Remote computer(s) 1338 is logically connected to computer 1302 through a network interface 1342 and then connected via communication connection(s) 1344. Network interface 1342 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL), digital video broadcasting (DVB), satellite (SAT) TV, IP, and over the top (OTT) content.

Communication connection(s) 1344 refers to the hardware/software employed to connect the network interface 1342 to the bus 1308. While communication connection 1344 is shown for illustrative clarity inside computer 1302, it can also be external to computer 1302. The hardware/software necessary for connection to the network interface 1342 includes, for exemplary purposes only, internal and external technologies such as, modems including regular telephone grade modems, cable modems and DSL modems, ISDN adapters, and wired and wireless Ethernet cards, hubs, and routers.

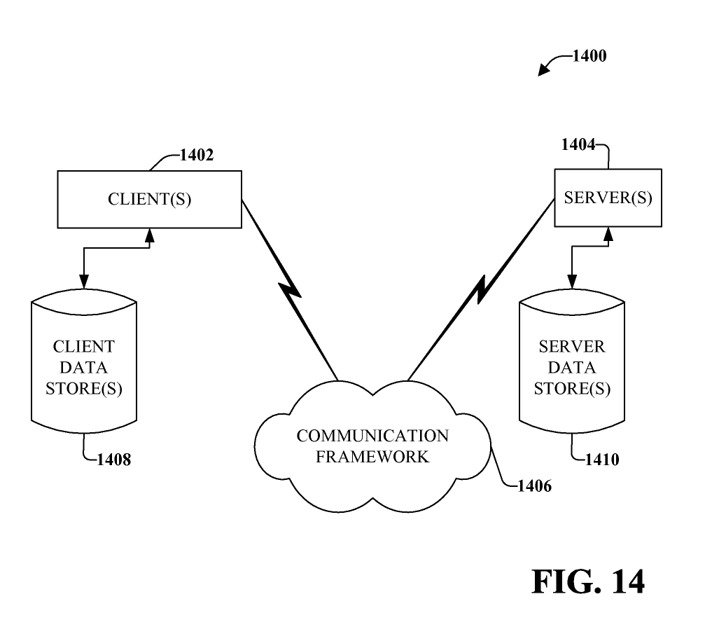

Referring now to FIG. 14, there is illustrated a schematic block diagram of a computing environment 1400 in accordance with this disclosure. The system 1400 includes one or more client(s) 1402 (e.g., laptops, smart phones, PDAs, media players, computers, portable electronic devices, tablets, and the like). The client(s) 1402 can be hardware and/or software (e.g., threads, processes, computing devices). The system 1400 also includes one or more server(s) 1404. The server(s) 1404 can also be hardware or hardware in combination with software (e.g., threads, processes, computing devices). The servers 1404 can house threads to perform transformations by employing aspects of this disclosure, for example. One possible communication between a client 1402 and a server 1404 can be in the form of a data packet transmitted between two or more computer processes wherein the data packet may include video data. The data packet can include a metadata, such as associated contextual information for example. The system 1400 includes a communication framework 1406 (e.g., a global communication network such as the Internet, or mobile network(s)) that can be employed to facilitate communications between the client(s) 1402 and the server(s) 1404.

Communications can be facilitated via a wired (including optical fiber) and/or wireless technology. The client(s) 1402 include or are operatively connected to one or more client data store(s) 1408 that can be employed to store information local to the client(s) 1402 (e.g., associated contextual information). Similarly, the server(s) 1404 are operatively include or are operatively connected to one or more server data store(s) 1410 that can be employed to store information local to the servers 1404.

In one embodiment, a client 1402 can transfer an encoded file, in accordance with the disclosed subject matter, to server 1404. Server 1404 can store the file, decode the file, or transmit the file to another client 1402. It is to be appreciated, that a client 1402 can also transfer uncompressed file to a server 1404 and server 1404 can compress the file in accordance with the disclosed subject matter. Likewise, server 1404 can encode video information and transmit the information via communication framework 1406 to one or more clients 1402.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the various embodiments. Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the various embodiments are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the various embodiments include a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the various embodiments may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A system, comprising:
a memory having stored thereon executable components; and
a processor, coupled to the memory, configured to execute or facilitate execution of the executable components, the executable components comprising:
a customization component that facilitates creation of a channel comprising video content, a brand, a graphic identity, and at least one feature of the channel, wherein the channel is represented by a channel card displayable from a channel store storing channels representing channel cards;
a management component that facilitates management of operations of the channel comprising a channel broadcast operation, a channel editing operation, and a channel consumption operation;
a reporting component that collects channel financial information comprising payment information for payment from a first party to a second party, or billing information for billing the first party; and
an analytical component that generates channel analytics information regarding the consumption of the channel or a behavior of an identity associated with the consumption of the channel.

2. The system of claim 1, wherein the at least one feature of the channel comprise providing any one or more of a live broadcast of the video content, a previous broadcast of the video content, a channel trailer, a channel preview demonstration, a listing of popular programs, content metadata, a period of time to access previously broadcasted video content or live video content, video quality options, availability of the video content at numerous devices, availability of the video content from the channel streaming over wi-fi or a cellular network, availability of channel content for downloading, territorial availability of the channel, options to group the video content, video content prohibited from consumption, billing periods for access to the channel and corresponding prices associated with the access, payment options, and trial options for accessing the channel.

3. The system of claim 1, wherein the executable components further comprise an editing component that facilitates an addition, a deletion, an editing, an acceptance, a rejection, or a publishing of the channel to the channel store.

4. The system of claim 1, wherein the executable components further comprise a receiver component that receives a set of broadcast signals corresponding to a set of video content, and wherein the set of broadcast signals comprises at least one of an internet protocol broadcast signal, a digital video broadcast signal, analog video signal, or a serial digital interface broadcast signal from at least one broadcast or IP source.

5. The system of claim 4, wherein the executable components further comprise a grouping component that groups the set of broadcast signals corresponding to the set of video content into subsets of video content based on a topic, a brand, a price or an event, a genre of the subset of video content.

6. The system of claim 5, wherein the executable components further comprise a tagging component that tags the subset of video content with keywords, terms, or labels to facilitate description of the subset of video content.

7. The system of claim 1, wherein the executable components further comprise a transcoding component that transcodes data streams from at least one source to target formats corresponding to target devices to which the data streams are to be transmitted.

8. The system of claim 1, wherein the management of the channel broadcast operation comprises management of metadata and electronic program guides, a promotional video, a channel rules or a data stream related to the video content.

9. The system of claim 1, wherein the management of the channel editing operation comprises management of an addition of the channel to the channel store, a deletion of the channel from the channel store, an edit of the channel, or a publishing of the channel to the channel store by an authorized administrator of the system.

10. The system of claim 1, wherein the executable components further comprise a billing component that determines a payment related to the channel purchased by a consumer.

11. A method, comprising:
broadcasting, by a system comprising a processor, channels to a first device using a first broadcast format or IP stream and to a second device using a second broadcast format or IP stream;
approving registration information received as input from a user identity associated with a subscription to a broadcast service of the system;
creating a channel comprising video content, a specification for the channel, and a feature for the channel; and
receiving a request to publish the channel to a channel store comprising the channels managed by the system.

12. The method of claim 11, further comprising, in response to the receiving the request, publishing the channel to the channel store.

13. The method of claim 11, wherein the feature comprises at least one of a channel name, a logo, promotional video content, or highly viewed video content.

14. The method of claim 11, wherein the specification comprises a channel price, a trial term for a subscription, a term for the subscription, a source of a broadcast or IP stream, a channel video stream and sound quality and characteristics, another term applicable to streaming of an electronic programming guide, defined video content of the channels to not broadcast to the first device or the second device, defined device types for video content availability, defined territories for channel or video content availability, or alternate ways to deliver the video content.

15. The method of claim 11, further comprising establishing a term subscription fee, a subscription fee corresponding to a video quality, or a royalty fee for the broadcast service.

16. The method of claim 11, further comprising verifying the registration information for the user identity associated with the broadcast service.

17. A computer readable storage device comprising executable instructions that, in response to execution, cause a system comprising a processor to perform operations, comprising:
approving a registrant identity for creation of a channel for the system configured to broadcast the channel according to a first broadcast format to a first device and according to a second broadcast format to a second device;
managing registration information received from the registrant identity, operations directed by the registrant identity and channel information corresponding to the channel created by the registrant identity; and
publishing the channel to a channel store comprising the channel in a set of published channels accessible via the channel store or unpublishing the channel from the channel store.

18. The computer readable storage device of claim 17, wherein the operations further comprise editing metadata and electronic program guide, corresponding to the channel.

19. The computer readable storage device of claim 17, wherein the operations further comprise collecting a subscription fee from a payment account associated with the registrant identity.

20. The computer readable storage device of claim 17, wherein the operations further comprise generating a report accessible to the registrant identity comprising financial information about at least a financial performance of the channel or analytics information about at least a usage of the channel.
